(19) United States
(12) Patent Application Publication
(10) Pub. No.: US 2004/0042684 A1
(43) Pub. Date: Mar. 4, 2004

(54) METHOD FOR SCANNING THE IRREGULAR OBJECT

(76) Inventors: Linda Liu, Taichung Hsien (TW); Shih-Wen Chen, Taichung (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/249,421

(22) Filed: Apr. 8, 2003

(30) Foreign Application Priority Data
Sep. 3, 2002 (TW) 91120045

(51) Int. Cl. G06T 3/00; G06T 3/40; G06T 7/00; G06K 9/32

(52) U.S. Cl. 382/282; 382/320; 382/163; 382/298

(57) ABSTRACT

A method for scanning the irregular object. The present invention allows the user to use charting tools such as a painting brush, a straight line, or a curve, etc., to directly frame the object (including the irregular object) required by themselves for the preview image to be scanned. Thus, when the framed object is the irregular object, the scanned irregular object can be directly used, but with the requirement of delivering the scanned irregular object to the image processing software to be processed. Also, the present invention allows the user to frame the object (including the irregular object) required by themselves in an intuitive manner, but framing the desired scanning object in the fixed rectangle.

### CROSS REFERENCE TO RELATED APPLICATIONS

This application claims the priority benefit of Taiwan application serial no. 91120045, filed September 03, 2002.

### BACKGROUND OF INVENTION

1. Field of Invention

The present invention generally relates to a method for scanning objects, and more particularly, to a method for scanning the irregular object.

2. Description of Related Art

A scanner is a machine providing the function between the copier and the camera. Since it has been very expensive, it has been almost a special privilege for professionals. Recently, due to the great progress of computer technology, and the advantage of cost reduction resulting from high competition in the scanner market, tthe scanner has entered into the main stream of the personal computer world, and has become a major personal computer peripheral device.

Scanners can be divided into several types according to price and supporting functions. Basically, the general scanner can be roughly divided into the palm scanner, paper-feeding scanner, business card scanner, film scanner, and flat scanner. The flat scanner is similar to a glass platform—a document or graph is put on the flat glass first, and then data is read in by moving the sensor. Since it is not so complicated, is easy to use and has a high level of functional expandability, the flat scanner has become a main stream of the scanners chosen by current computer users.

Currently, when the user intends to scan an object in the document by using the scanner, it is quite common to use a fixed rectangle in the preview window of the scanner driving program to frame the object. However, if the object is an irregular object, the user cannot use such method to directly frame the object in an intuitive manner. Further, after the irregular object framed by the fixed rectangle is scanned, it has to be processed by using the image processing software, so that it can be the same as the physical image of the irregular object. Therefore, such method does not support an intuitive type of operation manner, and its process is quite complicated.

### SUMMARY OF INVENTION

To solve the problem mentioned above, the present invention provides a method for scanning the irregular object. The present invention allows the user to use a charting tool such as a painting brush, a straight line, or a curve, etc., to directly frame the object (including the irregular object) required by themselves for the preview image to be scanned. Thus, when the framed object is the irregular object, the scanned irregular object can be directly used, but with the requirement of delivering the scanned irregular object to the image processing software to be processed.

In order to achieve the object mentioned above and others, the present invention provides a method for scanning the irregular object. In such method, at first, in the preview window, a charting tool is used to frame the object so as to obtain an object frame, and the object frame comprises a plurality of rows and a plurality of columns. Then, a starting point and an end point of each row is recorded. Then, the left top point of the object frame is calculated based on the highest point and the most left point of the frame object, and the right bottom point of the object frame is calculated based on the lowest point and the most right point of the frame object. Then, scanning is performed on a range of an area from the left top point to the right bottom point to obtain a scanned object frame. The scanned object frame comprises the object frame and a background portion. Finally, the background color is removed from the background portion.

In the preferred embodiment of the present invention, the step of removing the background color from the background portion comprises the steps of: at first, removing a background color of the background portion. Then, the removing of the background color ceases when a starting point of one row in the rows of the object frame is reached. Then, the end point of this row is found. Finally, the removing of the background color continues until the background color is completely removed from the background portion. Moreover, the step of removing the background color from the background portion further comprises the step of: when the starting point of the row in these rows of the object frame is not reached, the flow returns back to the step of removing the background color from the background portion.

In the preferred embodiment of the present invention, if the object is too small, a magnifier can be used to magnify the object, so as to facilitate the user for using the charting tool to frame the object.

In the preferred embodiment of the present invention, the charting tool may be a painting brush, a straight line, or a curve, etc.

The present invention further provides a method for scanning the irregular object. In such method, at first, in the preview window, a charting tool is used to frame the object so as to obtain an object frame, and the object frame comprises a plurality of rows and a plurality of columns. Then, a starting point and an end point of each row are recorded. Then, the left top point of the object frame is calculated based on the highest point and the most left point of the frame object, and the right bottom point of the object frame is calculated based on the lowest point and the most right point of the frame object. Then, scanning is performed on a range of area from the left top point to the right bottom point to obtain a scanned object frame. The scanned object frame comprises the object frame and a background portion. Finally, the background color is removed from the background portion.

In a preferred embodiment of the present invention, the step of removing the background color from the background portion comprises the steps of: at first, removing the background color from the background portion. Then, the removing of the background color ceases when a starting point of one column in the columns of the object frame is reached. Then, the end point of this column is found. Finally, the removing of the background color continues until the background color is completely removed from the background portion. Moreover, the step of removing the background color from the background portion further comprises the step of: when the starting point of the column in these columns of the object frame is not reached, the flow returns back to the step of removing the background color from the background portion.

In summary, the present invention allows the users to use charting tools such as the painting brush, the straight line, or the curve, etc., to directly frame the object (including the irregular object) required by themselves for the preview image to be scanned. Thus, when the framed object is the irregular object, the scanned irregular object can be directly used, but with the requirement of delivering the scanned irregular object to the image processing software to be processed. Also, the present invention allows the users to frame the object (including the irregular object) required by themselves in an intuitive manner, but framing the desired scanning object in the fixed rectangle.

### BRIEF DESCRIPTION OF DRAWINGS

The accompanying drawings are included to provide a further understanding of the invention, and are incorporated in and constitute a part of this specification. The drawings illustrate embodiments of the invention, and together with the description, serve to explain the principles of the invention. In the drawings,

FIG. 1 schematically shows a flow chart of a method for scanning the irregular object of the preferred embodiment according to the present invention;

FIG. 2 schematically shows a graph of the object being scanned and framed by the charting tool in the preview window of the preferred embodiment according to the present invention;

FIG. 3 schematically shows a magnified graph of the object that is too small and intended to be scanned with the preferred embodiment according to the present invention;

FIG. 4 schematically shows a graph of the scanned object frame obtaining from scanning a range of an area from the left top point (X1, Y1) to the right bottom point (X2, Y2) of the preferred embodiment according to the present invention;

FIG. 5 schematically shows a flow chart of the method for removing the background color from the background portion of the preferred embodiment according to the present invention.

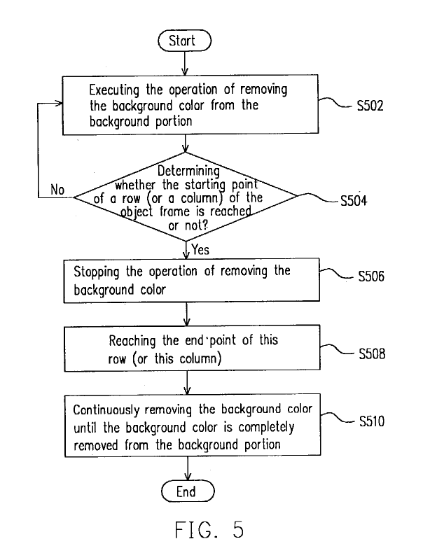

### DETAILED DESCRIPTION

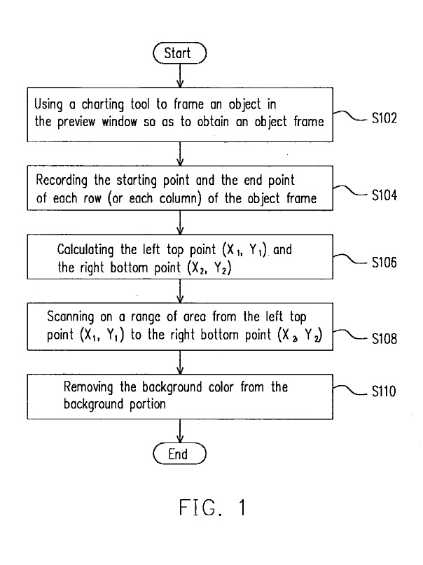

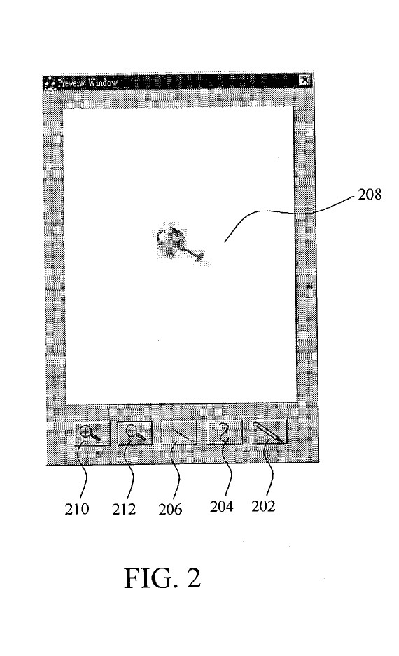

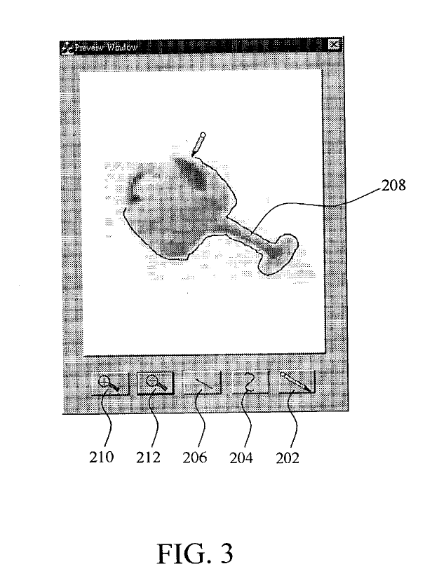

Referring to FIG. 1, it schematically shows a flow chart of a method for scanning the irregular object of the preferred embodiment according to the present invention. At first, when the user intends to select a desired object (including the irregular object) to be scanned, an object frame is obtained by using the charting tool to frame the desired object in an intuitive manner in the preview window after it is scanned in advance by the scanner, wherein the object frame comprises a plurality of rows and a plurality of columns (step S102). In order to have a better understanding of step S102, please referring to FIG. 2, it schematically shows a graph of the object 208 being scanned and framed by the charting tool in the preview window of the preferred embodiment according to the present invention. As shown in FIG. 2, the user uses a charting tool such as a painting brush 202, a curve 204, or a straight line 206 to frame the object 208 intended to be scanned. To be noted, although the charting tool shown in FIG. 2 is represented as the painting brush 202, the curve 204, or the straight line 206, it will be apparent to one of the ordinary skill in the art that other types of the charting tools also can be used as the charting tool of the present invention. However, if the object 208 is too small to frame, the user can use a magnifier 210 to magnify the object 208 so as to facilitate the user for framing it. Referring to FIG. 3, it schematically shows a magnified graph of the object 208 of the preferred embodiment according to the present invention, wherein the object 208 being scanned is too small, and the magnified graph is obtained by using the magnifier 210. Furthermore, if the object being framed by the user is too big, a reducer 212 is used to shrink the object so as to facilitate the user for framing it.

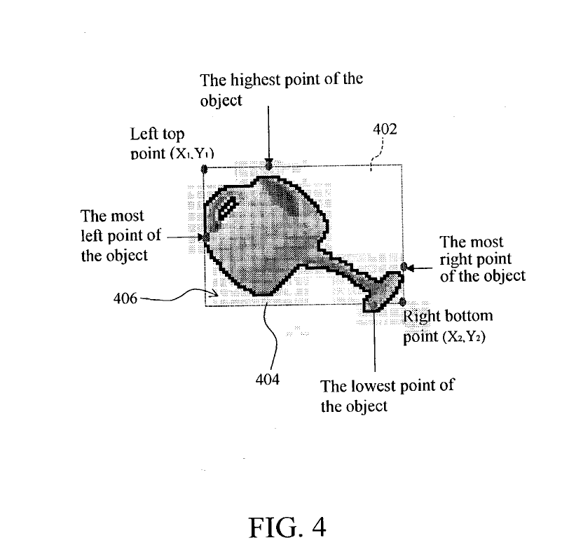

Then, the starting point and the end point for each row (or each column) of the object frame are recorded (step S104). Since the starting point and the end point for each row (or each column) of the object frame are all recorded, the highest point, the lowest point, the most left point, and the most right point of the object frame can be calculated. Then, the left top point (X1, Y1) of the object frame can be calculated based on the highest point and the most left point of the object frame, and the right bottom point (X2, Y2) of the object frame can be calculated based on the lowest point and the most right point of the object frame (step S106). Then, the scanner scans a range of area from the left top point (X1, Y1) to the right bottom point (X2, Y2) to obtain a scanned object frame (step S108). Referring to FIG. 4, it schematically shows a graph of the scanned object frame obtaining from scanning a range of area from the left top point (X1, Y1) to the right bottom point (X2, Y2) of the preferred embodiment according to the present invention. As shown in FIG. 4, the area marked as 402 is a scanned object frame. Since the scanner can only scan row by row (or column by column), the scanned object frame 402 obtained from scanning is different from the object frame 404 framed by the user. Therefore, the background color needs to be removed from the background portion 406 eventually (step S110).

Then, referring to FIG. S, it schematically shows a flow chart of the method for removing the background color from the background portion of the preferred embodiment according to the present invention. FIG. 4 is referred to for description hereinafter. At first, the step of removing the background color from the background portion 406 is executed (step S502). Then, it is determined whether the starting point of one row (or one column) of the object frame 404 is reached or not (step S504). Then, during the removing of the background color, the step of removing the background color is stopped when the starting point of this row (or this column) of the object frame 404 is reached (step S508). Finally, the removing of the background color continues until the background color in the background portion 406 is completely removed (step S510). Moreover, during the process of removing the background color, the flow returns back to the step S520 if the starting point of this row (or this column) of the object frame 404 is not reached.

In summary, the present invention allows the users to use charting tools such as a painting brush, a straight line, or a curve, etc. to directly frame the object (including the irregular object) required by themselves for the preview image to be scanned. Thus, when the framed object is the irregular object, the scanned irregular object can be directly used, but with the requirement of delivering the scanned irregular object to the image processing software to be processed. Also, the present invention allows the users to frame the object (including the irregular object) required by themselves in an intuitive manner, but framing the desired scanning object in the fixed rectangle.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

1. A method for scanning an irregular object, comprising:
using a charting tool to frame an object in a preview window so as to obtain an object frame, wherein the object frame comprises a plurality of rows and a plurality of columns;
recoding a starting point and an end point of each of the rows;
calculating a left top point of the object frame based on a highest point and a most left point of the object frame;
calculating a right bottom point of the object frame based on a lowest point and a most right point of the object frame;
obtaining a scanned object frame by scanning a range of area from the left top point to the right bottom point, wherein the scanned object frame comprises the object frame and a background portion; and
removing a background color from the background portion.

2. The method for scanning the irregular object of claim 1, wherein the step of removing the background color from the background portion further comprising:
removing the background color from the background portion;
stopping the removing of the background color when the starting point of one row in the rows of the object frame is reached;
finding the end point of the row; and
continuously removing the background color.

3. The method for scanning the irregular object of claim 2, wherein the step of removing the background color from the background portion further comprising:
returning back to the step of removing the background color from the background portion when the starting point of the row in the rows of the object frame is not reached.

4. The method for scanning the irregular object of claim 1, wherein when the object is too small, a magnifier is used to magnify the object so as to facilitate a user for using the charting tool to frame the object.

5. The method for scanning the irregular object of claim 1, wherein the charting tool is a painting brush.

6. The method for scanning the irregular object of claim 1, wherein the charting tool is a straight line.

7. The method for scanning the irregular object of claim 1, wherein the charting tool is a curve.

8. A method for scanning an irregular object, comprising:
using a charting tool to frame an object in a preview window so as to obtain an object frame, wherein the object frame comprises a plurality of rows and a plurality of columns;
recoding a starting point and an end point of each of the column;
calculating a left top point of the object frame based on a highest point and a most left point of the object frame;
calculating a right bottom point of the object frame based on a lowest point and a most right point of the object frame;
obtaining a scanned object frame by scanning a range of area from the left top point to the right bottom point, wherein the scanned object frame comprises the object frame and a background portion; and
removing a background color from the background portion.

9. The method for scanning the irregular object of claim 8, wherein the step of removing the background color from the background portion further comprising:
removing the background color from the background portion;
stopping the removing of the background color when the starting point of one column in the columns of the object frame is reached;
finding the end point of the column; and
continuously removing the background color.

10. The method for scanning the irregular object of claim 8, wherein the step of removing the background color from the background portion further comprising:
returning back to the step of removing the background color from the background portion when the starting point of the column in the columns of the object frame is not reached.

11. The method for scanning the irregular object of claim 8, wherein when the object is too small, a magnifier is used to magnify the object so as to facilitate a user in using the charting tool to frame the object.

12. The method for scanning the irregular object of claim 8, wherein the charting tool is a painting brush.

13. The method for scanning the irregular object of claim 8, wherein the charting tool is a straight line.

14. The method for scanning the irregular object of claim 8, wherein the charting tool is a curve.
